(19) United States
(12) Patent Application Publication
(10) Pub. No.: US 2026/0299521 A1
(43) Pub. Date: Oct. 1, 2026

(54) SMARTWATCH WITH ENHANCED SCREEN ACTIVATION AND ASSOCIATED METHOD

(71) Applicant: STMicroelectronics International N.V., Geneva (CH)

(72) Inventors: Thomas PEROTTO, Vaulnaveys le bas (FR); Guillaume DESBOIS, Grenoble (FR); Timothee FICHOT, Grenoble (FR); Charlotte MILANETTO, Grenoble (FR); Fabian HOLBACH, La Tronche (FR)

(21) Appl. No.: 19/569,784

(22) Filed: Mar. 17, 2026

(30) Foreign Application Priority Data
Mar. 27, 2025 (FR) 2503144

(51) Int. Cl. G04G 21/02; G01S 17/04

(52) U.S. Cl. CPC G04G 21/025; G01S 17/04

(57) ABSTRACT

A smartwatch comprises a display screen with enhanced activation control. Photoplethysmography-type and gyroscopic sensors are used to detect the use of the watch when its screen is off. A time-of-flight sensor is activated upon detection of this use. The object closest to the sensor is identified and isolated from the depth images acquired by the ToF sensor. The average depth of the isolated object is compared to threshold values, as well as an average reflectance of the isolated object to other threshold values, making it possible to detect the presence of an object resembling an individual in the sensor’s field of view. A determination of a match of the isolated object with a human person profile makes it possible to definitively validate the presence of the user in the sensor’s field of view. In response to this, the screen is turned back on.

### CROSS-REFERENCE TO RELATED APPLICATIONS

This patent application claims priority to and benefit to French Application No. 2503144 filed Mar. 27, 2025, the contents of which are incorporated herein by reference in its entirety.

### FIELD OF INVENTION

Embodiments and implementations relate to the field of smart or connected watches.

### BACKGROUND

Smartwatches offer, beyond merely displaying the time and date, computer-like calculation functions to typically implement an embedded operating system and numerous applications (gaming, communication, audiovisual, etc.).

In addition to computer resources, they are equipped with an electronic display screen that serves as the watch dial and occupies most of the visible face of the watch. The screen is usually touch-sensitive, but additional buttons can be used to complete the human-machine interface.

Smartwatches are powered by a battery, usually rechargeable. The electronic display screen and possibly some of the computer resources can be put into standby mode, i.e., not powered by the battery, when the watch is not in use.

To facilitate the user experience, mechanisms for waking up (or reactivating) the standby components have been implemented, based on the detection of a wrist movement from measurements of an embedded gyroscope. Typically, the electronic display screen is turned back on when the watch detects a wrist movement, allowing time display and access to applications.

However, feedback shows dissatisfaction with current wake-up mechanisms. In particular, inadvertent reactivations have been reported, leading to unnecessary energy consumption and therefore a reduced battery life of the watch. While some inadvertent reactivations are linked to incorrect calibration of the wrist movement detection thresholds (i.e., too high sensitivity of the watch), others are linked to an activity (climbing, running) that actually generates wrist movements but does not require the watch to wake up.

It should also be noted that the detection of a wrist movement uses time filters integrating the gyroscope signals. However, these time filters introduce latency in the wake-up mechanisms, which is detrimental to a good user experience, for example during sustained sporting effort during which the user wants to see the time of a rapid movement.

Finally, these current wake-up mechanisms do not allow normal use of the watch when it is not worn on the wrist, typically when it is placed on a table. To display the time, the user has to pick it up and shake it, making the experience unpleasant.

There is therefore a need to improve the wake-up mechanisms of smartwatches, in particular to improve the user experience.

### SUMMARY

The aim of the present disclosure is to overcome all or some of the drawbacks of known techniques.

By integrating a time-of-flight (ToF) sensor into the watch, it is possible to detect the presence of a person in front of the watch face, in order to reactivate the display accordingly. Therefore, inadvertent reactivations are reduced or even avoided, leading to reduced power consumption and increased battery life.

For this purpose, a screen wake-up system is provided in a watch equipped with an electronic display screen, the system comprising: a usage detection unit configured to detect, from measurements of at least one first sensor, a usage of the watch whose electronic display screen is off (i.e., not powered), a user detection unit comprising a time-of-flight (ToF) sensor activated upon detecting a use of the watch by the usage detection unit, the user detection unit being configured to determine a presence of a user in a field of view (FoV) of the ToF sensor, and a screen power management unit configured to switch on (i.e., power up) the electronic display screen in an event where a user is present in the FoV.

The system thus proposed has a reduced power consumption insofar as the ToF sensor is not activated permanently, but only when the watch is used.

Unlike conventional cameras, the ToF sensor used in the present disclosure further offers lower power consumption, reduced processing of acquired signals (e.g., images), and easier integration (particularly due to the reduced dimensions of the ToF sensor). In addition, its versions based on infrared (or near-IR) radiation offer a wider range of use, especially in a dark environment.

The present disclosure also relates to a smartwatch comprising an electronic display screen and a screen wake-up system as defined above to turn on (i.e., power up) the electronic display screen in the event where a user is present in the FoV of the ToF sensor.

Correspondingly, a method for waking a screen in a watch equipped with an electronic display screen is proposed, with the method comprising the following steps: detecting, from measurements of at least one first sensor, a use of the watch whose electronic display screen is switched off (i.e., not powered), activating a time-of-flight (ToF) sensor upon detecting the use of the watch, determining the presence of a user in a field of view (FoV) of the ToF sensor, and switching on (i.e., powering up) the electronic display screen if a user is present in the FoV.

Optional features of embodiments are defined in the appended claims. Some of these features are explained hereinbelow with reference to a method, while they could be transposed into structural features.

In one embodiment, the ToF sensor generates a depth signal and an amplitude signal, and the user detection unit is configured to compare depth information derived from the depth signal with at least one depth threshold value, and to compare reflectance information derived from the depth and amplitude signals with at least one reflectance threshold value. The reflectance can typically be calculated as a function of a product of the amplitude with the square of the corresponding depth (or distance) (e.g., pixel by pixel). The distance (depth)-reflectance combination enables simple but also reliable detection of an individual near the watch.

In a particular embodiment, the user detection unit signals the presence of a user in the FoV when the depth information and the reflectance information respectively satisfy the depth threshold value and reflectance threshold value.

In a particular embodiment, the ToF sensor is a single-zone sensor. This configuration offers the benefit of a low-cost design. Only one depth information and one amplitude information are then generated at each measurement (or acquisition) time.

In a particular embodiment, the ToF sensor is a multi-zone sensor generating a depth image (or depth map) as a depth signal and an amplitude image as an amplitude signal, and the user detection unit is configured to isolate, from the depth image, an object closest to the ToF sensor, in order to calculate the depth information as an average of the depths of the isolated object, and to calculate the reflectance information as an average of reflectance information of the isolated object.

This configuration allows for more accurate detection, as it is isolated on the nearest object.

In an even more particular embodiment, the user detection unit is configured to determine whether the isolated object matches a human person profile and to signal the presence of a user in the FoV in an event where a match is determined. This configuration allows for even more accurate detection.

In an even more particular embodiment, the determination of a match with a human person profile is activated only when the depth information and the reflectance information respectively satisfy the depth threshold value and reflectance threshold value. This configuration limits the consumption of resources since this match determination uses more resources than the comparisons of depth and amplitude information with threshold values.

In one embodiment, the ToF sensor is disposed in a bezel surrounding the electronic display screen, with a detection surface of the ToF sensor being inclined relative to a plane of the electronic display screen. This arrangement reduces the detection time - and therefore the time for the screen to turn on - because, in a standard movement to read his watch, the user first appears in a lateral field of view.

In a particular embodiment, the detection surface of the ToF sensor is inclined towards the bottom of the watch, by an angle between 20° and 60°. This angle is defined in relation to a vertical axis between the top and bottom of a display of the electronic display screen (the top and bottom of the watch). Preferably, this angle is between 30° and 50°. This arrangement optimises the detection time - and therefore the time for the screen to turn on - because, in the majority of standard movements to read a watch, the user first appears in a low field of view of the watch.

In a particular embodiment, the ToF sensor is disposed in a lower portion of the bezel, relatively to a display orientation of the electronic display screen. Again, this layout fosters early detection of the user and therefore rapid activation of the display screen, as the lower part of the watch is generally the first disposed in front of the user during a movement to read the watch.

In one embodiment, the usage detection unit comprises a user watch wearing sensor and a motion sensor, activated upon detection of wearing the watch using the watch wearing sensor, with the usage detection unit signalling use of the watch when the motion sensor detects movement greater than a threshold value. This configuration reduces power consumption when there is no user, as the motion sensor is only activated when the watch is worn (detected).

In a particular embodiment, the watch wearing sensor comprises a photoplethysmography-type heart rate sensor, and the motion sensor comprises a gyroscope. This configuration reduces design and integration costs as such sensors are already present in many smartwatches.

In one embodiment, the usage detection unit comprises an ambient light sensor. Indeed, a variation in ambient light intensity may correspond to the presence of a user handling the watch.

In one embodiment, the user detection unit is configured to activate the ToF sensor at two different measurement frequencies depending on whether the usage detection unit detects that the watch is worn by the user or not.

The disclosure may take the form of fully hardware embodiments, fully software embodiments, or embodiments combining software and hardware aspects which may all be collectively referred to herein as “circuit”, “module”, or “system”. Thus, the disclosure may take the form of a computer program or a non-transitory computer-readable recording medium on which is recorded a computer program or a computer program product incorporated into any tangible expression medium (e.g., hard disk, semiconductor memory device) having a computer program code, the program including instructions for implementing the method when this program is executed by a processor, regardless of the programming language (e.g., an object language or other) and its form (e.g., as interpretable source code, partially compiled or fully compiled).

### BRIEF DESCRIPTION OF FIGURES

Other advantages and features of the disclosure will become apparent upon examining the detailed description of in no way limiting embodiments and implementations, and from the accompanying drawings, wherein:

FIG. 1 illustrates a smartwatch in accordance with various embodiments of the present disclosure;

FIG. 2 illustrates an example of a ToF sensor, in accordance with various embodiments of the present disclosure;

FIG. 3 illustrates, using a block diagram, a smartwatch configuration, in accordance with various embodiments of the present disclosure;

FIG. 4 illustrates, by way of a flowchart, screen power management steps, in accordance with various embodiments of the present disclosure;

FIG. 5 illustrates, using a flowchart, steps of detection of a user of the watch using a single-zone ToF sensor, in accordance with various embodiments of the present disclosure;

FIG. 6 illustrates, using a flowchart, steps of detection of a user of the watch using a multi-zone ToF sensor, in accordance with various embodiments of the present disclosure;

FIG. 7 illustrates a side cross-sectional view of the smartwatch of FIG. 1, in accordance with various embodiments of the present disclosure; and

FIG. 8 illustrates a hardware architecture for the smartwatch of FIG. 1, in accordance with various embodiments of the present disclosure.

### DETAILED DESCRIPTION

A smartwatch comprises a display screen with enhanced activation control. Photoplethysmography (PPG) and gyroscopic sensors are used to detect the use of the watch when its screen is off. A ToF sensor is activated upon detection of this use. The object closest to the sensor is identified and isolated from the depth images acquired by the ToF sensor. The average depth of the isolated object is compared to threshold values, as well as an average reflectance of the isolated object to other threshold values, making it possible to detect the presence of an object resembling an individual in the sensor’s FoV. A determination of a match of the isolated object with a human person profile makes it possible to definitively validate the presence of the user in the sensor’s FoV. In response to this, the screen is turned back on.

The same elements are designated by the same references in the various figures. In particular, the structural and/or functional elements common to the various embodiments may have the same references and may have identical structural, dimensional and material properties.

In the interest of clarity, only the steps and elements useful for the understanding of the described embodiments are shown and detailed. In particular, the functional and material embodiments proposed below do not represent all the components constituting a smartwatch, but only those necessary for understanding the operations described in this disclosure.

In the following description, when reference is made to qualifiers of absolute position, such as the terms ‘front’, ‘rear’, ‘top’, ‘bottom’, ‘left’, ‘right’, etc., or relative position, such as the terms ‘above’, ‘below’, ‘higher’, ‘lower’, etc., or to qualifiers of orientation, such as the terms ‘horizontal’, ‘vertical’, etc., such reference is made to the orientation of the figures unless specified otherwise.

Unless otherwise indicated, the terms “substantially”, “about”, “in the order of” mean to the nearest 10%, and preferably to the nearest 5%. Furthermore, the terms “between … and …” and equivalents mean that bounds are included, unless otherwise stated.

Furthermore, the terms “coupled” and “connected” refer to two elements coupled or connected to each other either directly or indirectly through one or more intermediate elements. On the other hand, the terms “directly coupled” and “directly connected” mean that the two elements are coupled or connected without any other intermediate element.

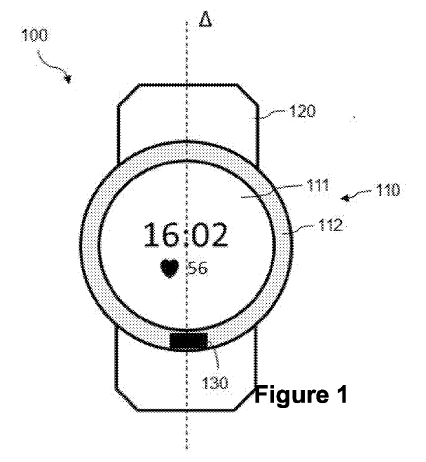

FIG. 1 illustrates a smartwatch 100 comprising a case 110 and a bracelet 120. The housing 110, generally round, square or rectangular, comprises an electronic display screen 111 forming a dial and typically (but not exclusively) of the OLED (organic light-emitting diode) or AMOLED (active matrix OLED) type, surrounded by a bezel 112. In particular, the screen 111 allows the display of information such as time, date or applications executed by the watch. The display orientation of the screen 111 defines a top and a bottom, and thus defines a vertical axis Δ of the watch 100.

The housing 110 also comprises, internally, electronic components (not illustrated) for “smart” operation of the watch, i.e., for behaviour similar to that of a computer. Mechanical buttons may also be provided (not illustrated) on the lateral edges of the housing 110.

The watch 100 further comprises a time-of-flight (ToF) sensor 130 for implementations of the present disclosure. As illustrated, the ToF sensor 130 is preferably disposed in the bezel 112 surrounding the electronic display screen 111, for example in a lower part of the bezel 112, given the display orientation of the electronic display screen. Other locations in the bezel may be considered, as well as a layout of the ToF sensor 130 behind the screen 111.

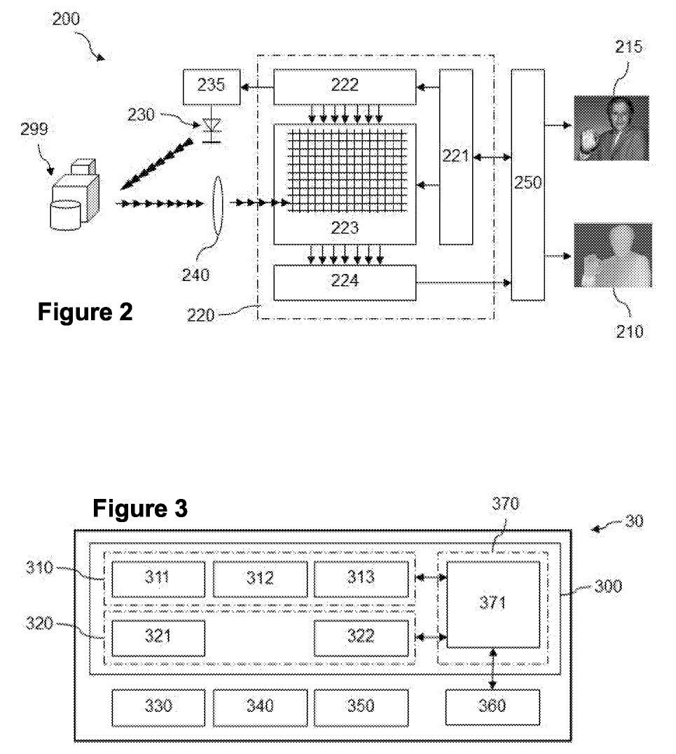

FIG. 2 illustrates an example of a ToF sensor in the form of a 3D (three-dimensional) ToF image sensor or imager 200.

A ToF imager 200 operates on the time-of-flight principle that projects a single source of modulated light - usually IR or near IR, for example between 850 or 940 nm - onto a target scene 299 in a field of view (or FoV). The reflected light is captured by the ToF imager, which measures the amplitude and phase difference for each pixel. This results in an image 210 of distances (or depths) as well as an image 215 of grayscale amplitudes of the entire scene.

In the illustration of FIG. 2, a multi-zone ToF imager 200 is used, obtaining distance/depth and amplitude information for a plurality of pixels. As a variant, single-zone ToF sensors only perform one measurement at each acquisition time.

The main components of the ToF imager 200 are the photographic sensor 220 sensitive to IR or near IR, an IR or near IR light source 230 (for example a light-emitting diode or a VCSEL laser) with a driver circuit 235 for generating the modulated light, imaging optics (typically one or more optical lenses) 240 at the top of the photographic sensor 220, as well as a processing unit 250 for generating images 210 and 215 from the signals acquired by the photographic sensor 220.

A sequence controller 221 of the photographic sensor 220 controls a modulation driver 222 to deliver an illumination modulation signal to the driver circuit 235. The IR light thus modulated is emitted by the source 230, in the FoV, to the scene 299.

The reflected light is directed by the imaging optics 240 to a pixel array 223 of the photographic sensor 220. The modulation driver 222 receives a control signal from the sequence controller 221 and emits a modulation signal to the pixel array 223 in order to acquire physical signals for each pixel. Each pixel of the pixel array 223 demodulates the reflected modulated light signal using the modulation signal, during the acquisition of an image to generate a measurement signal. The pixel array 223 comprises for example 240 x 180 pixels.

The acquired physical measurement signals are converted into digital signals by the A/D converter 224, which are provided to the processing unit 250 for generating the depth image 210 and the amplitude image 215 at each time of acquisition. In particular, the processing unit 250 calculates the depth pixel by pixel based on the converted measurement signals, in particular from measured phase difference information. Thus, the depth image 210 of the FoV can be generated.

FIG. 3 illustrates, using a block diagram, a smartwatch configuration according to embodiments.

Referring to FIG. 3, the smartwatch 30 may include a screen wake-up system 300 coupled to a display unit 360 or “screen”, as well as a battery unit 330, a storage unit 340, and an I/O unit 350. The screen wake-up system 300 comprises a usage detection unit 310, a user detection unit 320, and a control unit 370, coupled together. The smartwatch 300 may be provided with standard additional functional units, the description of which is of minor interest to the present disclosure. By way of example, the smartwatch 300 may also be equipped with a communication unit executing a communication function to and from an external server.

The usage detection unit 310 may comprise one or more sensors 311, 312 and a usage control unit 313 coupled to the sensors. The control unit 313, generally implemented in the form of computer code, is configured to detect, from measurements of the sensor(s) 311, 312, a use of the watch when the screen 360 is turned off (or not powered).

In an embodiment as illustrated, two sensors are used that can be sequentially activated one after the other by the control unit 313, in order to reduce the power consumption of the unit 310.

The sensor 311 may be a user watch wearing sensor, i.e., a sensor capable of determining whether the watch is actually worn by the user or not. Such a sensor may in particular comprise a heart rate sensor. The heart rate sensor 311 comprises for example a PPG (photoplethysmography) sensor for detecting the blood pressure. Such a sensor 311 is typically disposed under the housing 110 facing the user’s skin, when the watch is worn. The PPG sensor transmits an infrared signal to the skin and detects the returned signals, which are dependent on the absorption of light by the skin, which itself depends on local blood perfusion. Thus, the heart rate measurement signal can be transmitted, in real time, to the control unit 313.

The sensor 312 may be a motion or inertial sensor, for example, one or more acceleration sensors detecting linear acceleration and one or more two- or three-axis gyroscopic sensors, detecting two or three angular velocities. The sensor 312 may be placed inside the housing 110. The measurement signals are transmitted, in real time, to the control unit 313.

The control unit 313 activates and deactivates the sensors 311 and 312, and receives their measurement signals when they are activated.

The control unit 313 receives the heart rate measurement signal. The detection of blood activity in the received measurement signal allows the control unit 313 to conclude that a user is wearing the watch.

Similarly, the control unit 313 receives the motion measurement signal. The control unit 313 detects if a movement of the watch, as measured by the measurement signal, is greater than a threshold value. In particular, it is for the control unit 313 to detect a triggering movement (because sufficiently large) with a view to activation (turning on) of the screen 360.

Based on these two pieces of information (wearing detected and triggering movement detected), the usage control unit 313 is able to emit a watch usage signal. This information is used by the screen power (or standby) management unit 371 described hereunder to control the activation and deactivation of the screen 360 according to certain implementations.

The control unit 313 may first activate the watch wearing sensor 311, then activate the motion sensor 312 only in case of detection that the watch is worn by the sensor 311. Of course, the reverse order may be envisaged.

In an alternative not illustrated, a single sensor is coupled to the control unit 313 in the usage detection unit 310. This may be a single watch wearing sensor as already described, a single motion sensor as already described, or an ambient light sensor (ALS) arranged for example flush with the upper surface of the screen 111 or the bezel 112. Indeed, the control unit 313 can detect a variation in ambient light intensity in the measurement signal received from the ALS sensor, to conclude on the presence of a user near the watch and therefore handling it.

The heart rate sensor 311 and motion sensor 312 are therefore optional depending on the embodiments.

The user detection unit 320 comprises a ToF sensor 321 such as the sensor 200 of FIG. 2 and a presence monitoring unit 322 coupled to the sensor 321. The user detection unit 320 is configured to determine the presence of a user in the field of view (FoV) of the ToF sensor 321.

In one embodiment, the user detection unit 320 activates the ToF sensor 321 only when requested by the control unit 370 (as described below), in order to reduce power consumption.

The ToF sensor 321 generates a depth signal (or image) 210 and an amplitude signal (or image) 215 to the presence monitoring unit 322. That presence monitoring unit, generally implemented in the form of computer code, forms an image processing unit which can determine, within the signal or image obtained from the ToF sensor 321, a human presence or even a human form, and thus the presence of the user in the field of vision of the watch 30. This information is used by the screen power (or standby) management unit 371 described hereunder to control the activation and deactivation of the screen 360 according to certain implementations.

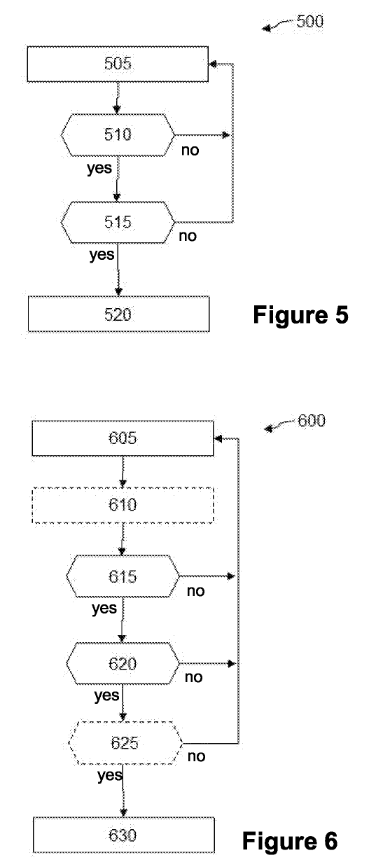

In embodiments illustrated below, for example in connection with FIG. 5 (for a single-zone ToF sensor) and FIG. 6 (for a multi-zone ToF sensor), the presence monitoring unit 322 is configured to compare depth information derived from the depth signal with at least one depth threshold value, and to compare reflectance information derived from the depth and amplitude signals with at least one reflectance threshold value. While the depth information can simply be the depth value itself in the measured image, the reflectance can be calculated as a function of a product of the amplitude with the square of the corresponding depth (or distance) (e.g., pixel by pixel).

In other embodiments illustrated below, for example in connection with FIG. 6, the presence monitoring unit 322 is configured to isolate, from the depth image of the multi-zone ToF sensor 321, an object closest to the ToF sensor, and then determine the presence of the user in the sensor’s FoV from an average depth and an average reflectance on the isolated object. Thus, the presence monitoring unit 322 is also configured to calculate the depth information as an average of the depths of the isolated object and calculate the reflectance information as an average of the reflectance information pieces of the isolated object.

Finally, in embodiments enabling the identification of a human form in the FoV of the sensor 321, the presence monitoring unit 322 is configured to determine whether the above isolated object corresponds to a human person profile and thus to signal the presence of a user in the FoV in the event where a match is determined. To do so, the presence monitoring unit 322 may implement conventional image or contour comparison mechanisms (here the formed image of the isolated object) with reference profiles. Alternatively, conventional classification methods by artificial intelligence can be implemented. The reference profiles or classes can be faces or human contours.

The battery 330 provides the energy necessary for the operation of the smartwatch 30. It can be recharged via a conventional charging unit (not shown).

The storage unit 340 may store various data necessary for the operation of the smartwatch 30. In particular, the storage unit 340 can store the computer code of the algorithms described hereunder, as well as the parameters used by these algorithms (e.g., threshold values, a detection profile of a human form).

The I/O unit 350 allows the user to interact with the watch 30, for example to configure it or interact with the applications being executed. The I/O unit 350 may include the display unit 360 when the display screen is a touchscreen. The I/O unit 350 may include side buttons (not shown), which can be operated by the user.

The display unit 360 typically comprises a display screen, for example OLED or AMOLED. For smartwatches, the screen size is a few hundred pixels, for example 320 x 320 pixels or 480 x 480 pixels.

The display unit 360 may display an interface comprising data such as time, date, battery status, and any information related to applications executed by the watch 30. As will be described hereunder, the activation and deactivation of the display unit 360 may be controlled by the screen power (or standby) management unit 371 described hereunder. “Activating” or “deactivating” means waking it up or putting it on standby, i.e., supplying it with power or interrupting its power supply, respectively.

The control unit 370, generally implemented in the form of computer code, controls the general operation of the watch 30. More specifically, the control unit 370 may control all or part of the battery unit 330, the storage unit 340, the display unit 360, and the I/O unit 350.

In particular, the control unit 370 comprises the screen power (or standby) management unit 371 that controls the usage detection unit 310, the user detection unit 320, and the power on/off of the display unit 360.

The screen power management unit 371 determines whether the standby conditions are met to control standby of the display unit 360 accordingly. Symmetrically, the screen power management unit 371 determines, as explained hereunder, whether the wake-up conditions are met to control the wake-up of the display unit 360 accordingly. In particular, the screen power management unit 371 is configured to switch on (i.e., power up) the electronic display screen in the event where a user is present in the FoV.

In other embodiments, the power supply to other components of the watch, for example communication interfaces, processors, and/or memories, may be controlled in the same manner to further reduce instantaneous consumption.

FIG. 3 clearly illustrates the functional usage control units 313, presence monitoring units 322 and control units 370. These units, produced by computer codes, may nevertheless be part of the same computer software/program.

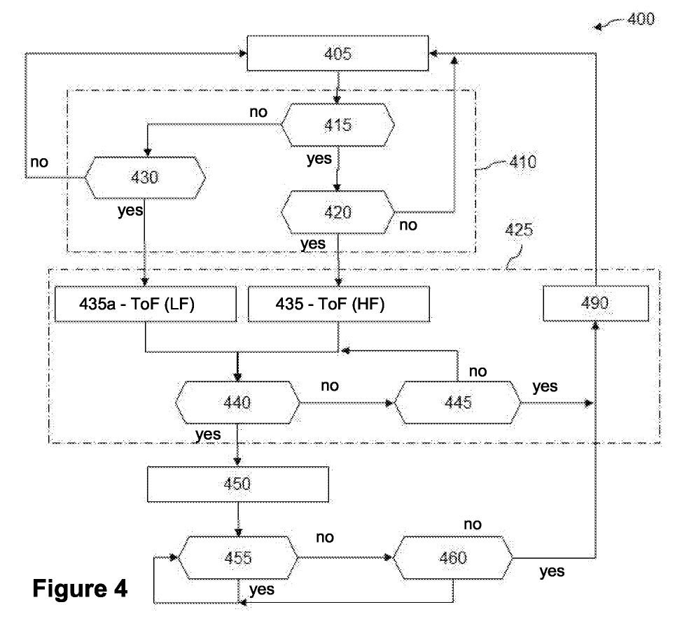

FIG. 4 illustrates, by way of a flowchart, screen power management steps according to some embodiments. The method 400 of FIG. 4 may in particular be coordinated by the screen power management unit 371.

In step 405, the screen 360 is put into sleep mode, i.e., its power supply is switched off for the purpose of saving energy.

Then step 410 begins, for detecting, from measurements of at least one first sensor, whether the watch is being used or not. In particular, this step implements the usage detection unit 310. Thus, to initiate step 410, the screen power management unit 371 activates the usage detection unit 310.

The operations 410 comprise, in step 415, activating the watch wearing sensor (or PPG sensor) 311 upon launching the usage detection unit 310, in order to determine whether the watch is actually being worn by a user. For example, a heart rate measurement signal is acquired by the sensor 311 and then transmitted to the control unit 313 which, in the event of presence of blood activity (heart rate present) in the received signal, concludes that a user is wearing the watch.

In such a case, the method continues at step 420, during which the usage detection unit 310 activates the motion sensor 312 to detect whether the user performs, with the watch, a triggering movement, i.e., a movement of the wrist (and therefore of the watch) sufficiently large to characterise, a priori, a desire of the user to activate his/her screen. Acquisition can be performed for a single acquisition time or for a predefined period of time (e.g., 20 ms).

By way of example, a gyroscopic measurement signal is acquired by the sensor 312 then transmitted to the control unit 313 which determines whether this signal contains a movement - for example an angular velocity - greater than a threshold value. The triggering movement test can be performed on measurements other than the angular velocity, for example an angular acceleration. It may further be performed from a measurement along one axis, or from a combination of measurements along several axes. In alternatives, the test can implement more complex wrist movement recognition mechanisms, for example by comparing measurements to movement profiles.

If no triggering movement is detected in step 420, the method returns to step 405. Conversely, if such a movement is detected, this information is reported back to the screen power management unit 371. The method then continues at step 425 described below.

If there is no watch wearing detection in step 415, the watch may simply be placed on a table with the user next to it. Thus, in the optional step 430, the usage detection unit 310 activates an ALS sensor to detect if the user is approaching the watch (in which case the brightness decreases). For example, the ALS measurement signal acquired by the ALS sensor is transmitted to the control unit 313, which determines whether the brightness decreases significantly over time, i.e., whether the downward variation in brightness between two moments is greater than a threshold value. If not, the method returns to step 405; if yes, use of the watch is detected and reported back to the screen power management unit 371, and the method continues at step 425. In the absence of step 430, the method may directly proceed to step 425.

Thus, the usage detection operations by the usage detection unit 310 are terminated. Thus, upon initiation of step 425, and therefore upon detection of a use of the watch, the screen power management unit 371 activates the user detection unit 320 to determine the presence of a user in a field of view (FoV) of the ToF sensor 321.

Step 425 begins with step 435 (from 420) or 435a (from 430 or 415) where the user detection unit 320 activates the ToF sensor 321. In step 435, the ToF sensor 321 is set to a high acquisition frequency, whereas in step 435a, the ToF sensor 321 is set to a low acquisition frequency. A high acquisition frequency means more than 10 acquisitions per second (and therefore depth and amplitude images 210, 215 per second) i.e., 10 Hz, in particular more than 20 frames per second (20 Hz), or even more than 30 or 40 frames per second (30 or 40 Hz). Frequencies of 50 or even 100 Hz can also be considered. A low acquisition rate means less than half of the high acquisition frequency, for example, fewer than 5 frames per second (5 Hz), or even 2 or fewer frames per second (2 Hz).

Using a lower frequency in step 435a makes it possible to reduce the power consumption in the more uncertain case where wearing of the watch by a user was not detected (in step 415).

Alternatively, the same frequency may be used, meaning that steps 435 and 435a may form a single step.

The measurement signals of the ToF sensor 321 are transmitted to the presence monitoring unit 322 which determines, in step 440, whether the user is present in the field of view (FoV) of the sensor.

Embodiments of these determination operations are described hereunder in connection with FIGS. 5 and 6. As long as no user is detected, the operations of step 440 continue via step 445 which counts down a timeout, for example of a few seconds at most (e.g., 1 to 5 seconds).

If no detection was performed at the end of the timeout, the method continues at step 490 where the ToF sensor is stopped, as well as the user detection unit 320, and then at step 405 (the screen 360 of the watch is still off).

In case of detection at step 440, this information is reported back to the screen power management unit 371. Thus, the user detection operations by the user detection unit 320 are terminated.

The method then continues at step 450 where the screen power management unit 371 activates or turns on (i.e., powers up) the display 360 due to the presence of a user in the FoV of the watch. This step can simply involve repowering the screen 360 from the battery. At that moment, the watch will exit its sleep state and information (time, date, etc.) will be displayed to the user.

The conditions for returning the screen 360 to sleep mode may be multiple, without being the core of the present disclosure. Thus, the method can be stopped in this way. Nonetheless, FIG. 4 illustrates embodiments where step 450 of activating the screen 360 continues through steps 455 and 460 similar to steps 440 and 445 respectively. This is to determine whether the user disappears from the FoV of the ToF sensor 321 for a predefined period of time (corresponding to the timeout set for step 460). This predefined period of time may be different from that of step 445, and the timeout of step 460 will be reset each time the user is detected at step 455.

When no user is detected in the sensor’s FoV for the predefined period of time, the method continues at step 490 of deactivating the ToV sensor 321, already described.

FIG. 5 illustrates, using a flowchart, steps of detection of a user of the watch according to embodiments using a single-zone ToF sensor. The method 500 of FIG. 5 may correspond to the aforementioned steps 440 and 455, performed by the presence monitoring unit 322 from the signals acquired by the single zone ToF sensor 321.

Step 505 comprises obtaining new measurement signals acquired by the ToF sensor 321, in particular depth information and amplitude information (greyscale). The depth information can be expressed in cm (centimetres). The amplitude information (greyscale) can be expressed as a percentage between 0 (black) and 1 (white).

In step 510, the presence monitoring unit 322 compares the depth information with at least one depth threshold value, here a floor threshold value S1 and a ceiling threshold value S2. For example, S1 is 10 or 20 cm, and S2 is 40 to 60 cm, for example 50 cm. Thus, the presence monitoring unit 322 seeks to detect a user in a range of distances compatible with normal use of a watch.

If the depth information does not meet the threshold value(s) - here, if it is not between S1 and S2 - then no user is detected in the ToF sensor’s FoV. The method returns to step 505 to process the next acquired measurements.

If the threshold value(s) are met, an object or person is detected in the FoV of the ToF sensor. To ensure that it is a human, step 515 provides for comparing reflectance information calculated from the depth and amplitude information with at least one reflectance threshold value, here a floor threshold value S3 and a ceiling threshold value S4. For example, S3 is 30, 35, or 40%, and S4 is 60, 65, or 70%. Indeed, it has been found that the reflectance of humans remains within this value range, unlike the majority of objects.

The reflectance R can be calculated as a product (*) of the amplitude information A with the square of the depth information P (expressed in metres).

For example: R = A/A_{ref}, where A_{ref} is a corrected reference amplitude. This can be obtained by correcting a reference amplitude A_{ref0} determined during a calibration of the ToF sensor, for a target at 1% reflectance placed at one metre, by the depth P of the current measurement and a normalisation coefficient λ (typically to compensate for different acquisition modes between the initial calibration of the sensor and the acquisition during processing): for example, A_{ref} = A_{ref0}/P² * λ.

Thus, R can be written A * P² * λ', where λ' is a normalisation coefficient that takes into account the calibration of the ToF sensor.

Of course, other reflectance calculation formulas can be used.

If the reflectance information does not meet the threshold value(s) - here, if it is not between S3 and S4 - then no user is detected in the ToF sensor’s FoV. The method returns to step 505.

Conversely, if the threshold value(s) are met, a person is detected in the FoV of the ToF sensor. Thus, this information may be transmitted to the screen power management unit 371 in step 520.

It should be noted that steps 510 and 515 can be reversed, although the order of the Figure has the advantage of reduced power consumption since step 510 requires fewer calculations and step 515 is performed only in case of detection at step 510.

FIG. 6 illustrates, using a flowchart, steps of detection of a user the watch according to embodiments using a multi-zone ToF sensor. The method 600 of FIG. 6 may correspond to the aforementioned steps 440 and 455, performed by the presence monitoring unit 322 from the signals acquired by the multi-zone ToF sensor 321.

The multi-zone ToF sensor 321 generates a depth image 210 (or depth map) and an amplitude image 215 at each time of acquisition.

Step 605, like step 505, comprises obtaining new measurement signals acquired by the ToF sensor 321, in particular a depth image 210 and an amplitude image 215 (greyscale). The depth information at each pixel can be expressed in cm (centimetres). The amplitude information at each pixel can be expressed as a percentage between 0 (black) and 1 (white).

In the optional step 610, the presence monitoring unit 322 extracts, from the depth image 210, the object closest to the ToF sensor 321. By isolating an object in this way, it is possible not only to reduce the complexity of the calculations, but also to obtain a better characterization of the main object in the sensor’s FoV.

The method continues at step 615, similar to step 510, where the presence monitoring unit 322 compares depth information with the depth threshold value(s) (S1 and S2 in the example). The depth information to be compared is nevertheless calculated as the average of the depths of the isolated object, i.e., the average of the depths of the pixels making up the isolated object in step 610.

If the depth information does not meet the threshold value(s) - here, if it is not between S1 and S2 - then no user is detected in the ToF sensor’s FoV. The method returns to step 605 to process the next acquired images.

If the threshold value(s) are met, an object or person is detected in the FoV of the ToF sensor. To ensure that it is a human, step 620, like step 515, provides comparing reflectance information calculated from the depth and amplitude images with at least one reflectance threshold value (S3 and S4 in the example). The reflectance information to be compared is nonetheless calculated as the average of the reflectance information pieces of the isolated object, i.e., the average of the pieces of reflectance information of the pixels forming the isolated object in step 610.

The reflectance of a pixel can be calculated as a function of a product of the pixel amplitude information with the square of the pixel depth information, as set forth above.

If the reflectance information does not meet the threshold value(s) - here, if it is not between S3 and S4 - then no user is likely to have been detected in the ToF sensor’s FoV. The method returns to step 505.

Conversely, if the threshold value(s) are met, a person may have been detected in the ToF sensor’s FoV.

The optional step 625 then makes it possible to confirm that it is indeed a human being. In step 625, the presence monitoring unit 322 determines whether the isolated object in step 610 corresponds to a human person profile.

If this is not the case, then no user is detected in the ToF sensor’s FoV. The method returns to step 605.

Conversely, if this is the case, a person is detected in the FoV of the ToF sensor. Thus, this information is transmitted to the screen power management unit 371 in step 630.

Note that the order of the steps can be reversed. Nevertheless, it is preferable to activate the determination of a match with a human person profile at step 625 only when the depth information and the reflectance information (steps 615 and 620) respectively satisfy the threshold values of depth and reflectance. This configuration limits energy consumption because step 625 requires more calculations.

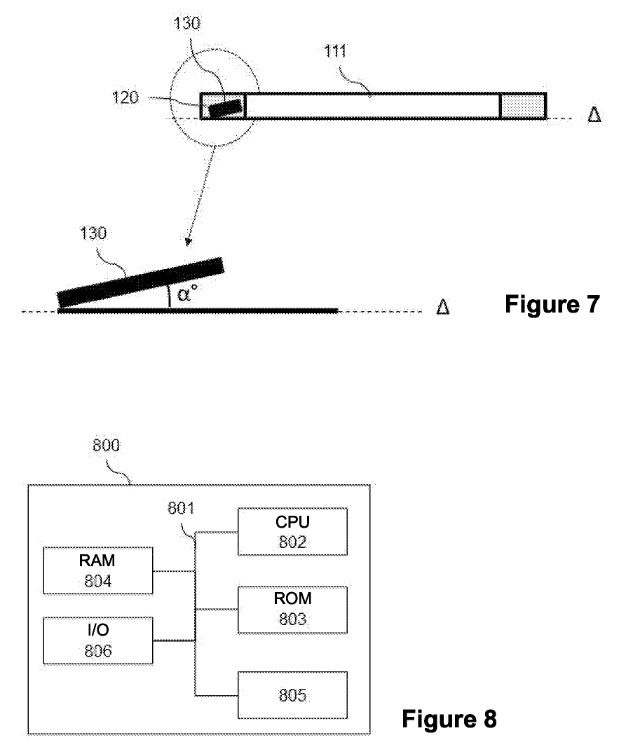

FIG. 7 illustrates, using a side cross-sectional view of the watch of FIG. 1 along the Δ axis, a hardware integration of the ToF sensor 130 into the smartwatch 100 according to embodiments.

As illustrated, the ToF sensor 130 is disposed in the bezel 112 surrounding the electronic display screen 111. A detection surface of the ToF sensor is inclined by an angle α relative to the plane of the screen 111.

The incline is performed towards the bottom of the watch, taking into account the display orientation of the screen 111 as shown in FIG. 1. The angle α may be between 20° and 60°, preferably between 30° and 50°, for example about 35°, 40° or 45°.

FIG. 8 illustrates a hardware architecture for the watch of FIG. 1. The watch 800 comprises a communication bus 801 to which the following are preferably connected: one or more central processing units 802, such as a microprocessor; a ROM-type and/or hard disk-type and/or flash-memory-type storage memory 803, for storing computer programs intended to implement all or some of the operations described above; a RAM or video RAM (VRAM) type random-access memory 804, for storing the executable code of the computer programs, as well as the registers suitable for recording variables and parameters necessary for execution thereof; one or more sensors 805 for acquiring measurement signals for implementing the operations described above; and one or more I/O units 806 enabling a user or administrator to interact with the computer programs, for configuration and exploitation. Typically, the I/O units include a display that is activated or deactivated according to the teachings of the present disclosure, and optionally other input or playback means, such as buttons and an integrated speaker.

The communication bus 801 ensures communication and interoperability between the various components included in the computer device 100 or connected thereto. The representation of the bus is not exhaustive.

Preferably, the central unit 802 is adapted to monitor and direct the execution of the instructions or software code portions of the computer program(s). When switched on, the program(s) stored in non-volatile memory 803 are transferred/loaded into the random access memory 804, which then contains the executable code of the program(s), as well as registers for storing the variables and parameters required to implement the disclosure.

Of course, the present disclosure is not limited to the embodiments described above by way of example; it extends to other variants. Other embodiments are possible.

1. A screen activation system in a watch equipped with an electronic display screen, the system comprising:
a usage detection unit configured to detect, from measurements of at least one first sensor, a usage of the watch whose electronic display screen is off;
a user detection unit comprising a time-of-flight (ToF) sensor activated upon detecting a use of the watch by the use usage detection unit, the user detection unit being configured to determine a presence of a user in a field of view (FoV) of the ToF sensor; and
a screen power management unit configured to switch on the electronic display screen in an event where a user is present in the FoV.

2. The system according to claim 1, wherein the ToF sensor generates a depth signal and an amplitude signal; and
wherein the user detection unit is configured to compare depth information derived from the depth signal with at least one depth threshold value, and to compare reflectance information derived from the depth signal and the amplitude signal with at least one reflectance threshold value.

3. The system according to claim 2, wherein the user detection unit signals the presence of a user in the FoV when the depth information and the reflectance information respectively satisfy the depth threshold value and reflectance threshold value.

4. The system according to claim 2, wherein the ToF sensor is a multi-zone sensor generating a depth image as a depth signal and an amplitude image as an amplitude signal; and
wherein the user detection unit is configured to isolate, from the depth image, an object closest to the ToF sensor, in order to calculate the depth information as an average of depths of the isolated object, and to calculate the reflectance information as an average of reflectance information of the isolated object.

5. The system according to claim 4, wherein the user detection unit is configured to determine whether the isolated object matches a human person profile and to signal the presence of a user in the FoV in an event where a match is determined.

6. The system according to claim 5, wherein the determination of a match with a human person profile is activated only when the depth information and the reflectance information respectively satisfy the depth threshold value and reflectance threshold value.

7. The system according to claim 1, wherein the ToF sensor is disposed in a bezel surrounding the electronic display screen, with a detection surface of the ToF sensor being inclined relative to a plane of the electronic display screen.

8. The system according to claim 7, wherein the detection surface of the ToF sensor is inclined towards the bottom of the watch, at an angle between 20° and 60°.

9. The system according to claim 7, wherein the ToF sensor is disposed in a lower portion of the bezel, relatively to a display orientation of the electronic display screen.

10. The system according to claim 1, wherein the usage detection unit comprises a user watch wearing sensor and a motion sensor, activated upon detection of wearing the watch using the watch wearing sensor, with the usage detection unit signalling use of the watch when the motion sensor detects movement greater than a threshold value.

11. The system according to claim 10, wherein the watch wearing sensor comprises a photoplethysmography-type heart rate sensor, and the motion sensor comprises a gyroscope.

12. The system according to claim 1, wherein the usage detection unit comprises an ambient light sensor.

13. The system according to claim 1, wherein the user detection unit is configured to activate the ToF sensor at two different measurement frequencies depending on whether the usage detection unit detects that the watch is worn by the user or not.

14. The system according to claim 1, wherein the ToF sensor is a single-zone sensor.

15. A smartwatch comprising:
an electronic display screen; and
a screen wake-up system for turning on the electronic display screen in an event where a user is present in a field of view (FoV) of a time-of-flight (ToF) sensor, the screen wake-up system comprising:
a usage detection unit configured to detect, from measurements of at least one first sensor, a usage of the smartwatch whose electronic display screen is off;
a user detection unit comprising the ToF sensor activated upon detecting a use of the smartwatch by the use usage detection unit, the user detection unit being configured to determine a presence of a user in the FoV of the ToF sensor; and
a screen power management unit configured to switch on the electronic display screen in an event where a user is present in the FoV.

16. The smartwatch according to claim 15, wherein the ToF sensor generates a depth signal and an amplitude signal; and
wherein the user detection unit is configured to compare depth information derived from the depth signal with at least one depth threshold value, and to compare reflectance information derived from the depth signal and the amplitude signal with at least one reflectance threshold value.

17. The smartwatch according to claim 16, wherein the user detection unit signals the presence of a user in the FoV when the depth information and the reflectance information respectively satisfy the depth threshold value and reflectance threshold value.

18. The smartwatch according to claim 16, wherein the ToF sensor is a multi-zone sensor generating a depth image as a depth signal and an amplitude image as an amplitude signal; and
wherein the user detection unit is configured to isolate, from the depth image, an object closest to the ToF sensor, in order to calculate the depth information as an average of depths of the isolated object, and to calculate the reflectance information as an average of reflectance information of the isolated object.

19. The smartwatch according to claim 15, wherein the ToF sensor is a single-zone sensor.

20. A method of screen activation in a watch equipped with an electronic display screen, the method comprising:
detecting, from measurements of at least one first sensor, a use of the watch whose electronic display screen is switched off;
activating a time-of-flight (ToF) sensor upon detecting the use of the watch;
determining a presence of a user in a field of view (FoV) of the ToF sensor; and
switching on the electronic display screen if a user is present in the FoV.
